(19) United States
(12) Patent Application Publication
(10) Pub. No.: US 2019/0108149 A1
(43) Pub. Date: Apr. 11, 2019

(54) I3C IN-BAND INTERRUPTS DIRECTED TO MULTIPLE EXECUTION ENVIRONMENTS

(71) Applicant: QUALCOMM Incorporated, San Diego, CA (US)

(72) Inventors: Sharon GRAIF, Zichron Yakov (IL); Lior AMARILIO, Yokneam (IL); Oren NISHRY, Haifa (IL)

(21) Appl. No.: 15/729,247

(22) Filed: Oct. 10, 2017

(51) Int. Cl. G06F 13/24; G06F 13/364; G06F 13/42; G06F 13/40; G06F 9/44

(52) U.S. Cl. CPC G06F 13/24; G06F 13/364; G06F 9/4418; G06F 13/404; G06F 13/4282

(57) ABSTRACT

Systems, methods, and apparatus for communication over a serial bus in accordance with an I3C protocol are described. A master device coupled to the serial bus may detect signaling on the serial bus corresponding to an in-band interrupt asserted by a slave device that is addressable by a first device identifier, receive a second device identifier transmitted by the slave device in relation to the in-band interrupt, use the second device identifier to select an execution environment, and interrupt the execution environment responsive to the in-band interrupt. The slave device may use the first device identifier in transactions conducted over the serial bus. After detecting an event generated by an event source, the slave device may initiate an in-band interrupt on the serial bus, and may transmit the second device identifier to indicate the event source during an in-band interrupt handling procedure.

### TECHNICAL FIELD

The present disclosure relates generally to an interface between processors and peripheral devices and, more particularly, to address allocation to devices adapted to communicate over a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. In one example, the serial bus may be operated in accordance with Inter-Integrated Circuit protocols, which may also be referred to as I2C protocols or PC protocols. The I2C protocols are operable on a serial, single-ended bus used for connecting low-speed peripherals to a processor. In some examples, a serial bus may employ a multi-master protocol in which one or more devices can serve as a master and a slave for different messages transmitted on the serial bus. Data can be serialized and transmitted in a data signal carried on a Serial Data Line (SDATA or SDA), in accordance with timing provided in a clock signal carried on a Serial Clock Line (SCLOCK or SCL).

In another example, the serial bus may be operated in accordance with I3C protocols defined by the Mobile Industry Processor Interface (MIDI) Alliance. The I3C protocol can increase available bandwidth on the serial bus through higher transmitter clock rates, by encoding data in symbols defining signaling state of two or more wires, and/or through other encoding techniques including double data rate transmissions where data is clocked using rising and falling edges of a transmitted clock signal. Certain aspects of the I3C protocol are derived from corresponding aspects of the I2C protocol, and the I2C and DC protocols can coexist on the same serial bus, the protocols used on an DC bus derives certain implementation aspects from the I2C protocol.

In some systems and apparatus, mobile communications devices such as cellular phones may employ multiple devices, such as cameras, displays and various communications interfaces that produce event notifications that can be directed to a consumer of such alerts. In some instances, an SoC can include multiple application processors and/or execution environments, each of which can be a consumer of an event notification. An execution environment may be equipped with processing resources and memory and may be configured to execute applications or procedures independently of other execution environments. In conventional systems, event notifications are handled by an application processor that determines source and nature of the underlying event and one or more destinations for the event notification. The processing overhead associated with event handling can introduce significant latencies, particularly in complex applications.

### SUMMARY

Certain aspects of the disclosure relate to systems, apparatus, methods and techniques in which slave devices coupled to a serial bus may be provisioned with multiple dynamic addresses, some of which can be used to identify an event source during an in-band interrupt. The serial bus may be operated in accordance with an I3C protocol.

In various aspects of the disclosure, a method performed at a device coupled to the serial bus includes detecting signaling on the serial bus corresponding to an in-band interrupt asserted by a slave device, the slave device being associated with a first device identifier, receiving a second device identifier transmitted by the slave device in relation to the in-band interrupt, using the second device identifier to select a first execution environment, and interrupting the first execution environment responsive to the in-band interrupt.

In certain aspects, the slave device includes a plurality of event sources. Device identifiers may be assigned to the plurality of event sources for use in identifying sources of events generated by the plurality of event sources. A list may be maintained that associates an execution environment with each device identifier assigned to an event source. The first execution environment may be selected using the list. Assigning the device identifiers to the plurality of event sources may include writing the device identifiers to registers associated with the plurality of event sources. Assigning the device identifiers to the plurality of event sources may include allocating the first device identifier to the slave device during a first dynamic address allocation process. The second device identifier may be allocated to the slave device during a second dynamic address allocation process. The second device identifier may be written through the serial bus to a register in the slave device associated with a first event source.

In one aspect, the master device is operating in a sleep mode when the signaling corresponding to an in-band interrupt is detected, and interrupting the first execution environment includes waking the first execution environment. A second execution environment may be unaffected when the first execution environment is interrupted.

In various aspects of the disclosure, an apparatus has a bus interface operable as a bus master interface and adapted to couple the apparatus to a serial bus, a plurality of execution environments, each configured to perform one or more functions independently of another execution environment, and a list of device identifiers allocated to a slave device, the list associating each device identifier with one of the plurality of execution environments. The bus interface may be configured to detect signaling on the serial bus corresponding to an in-band interrupt asserted by the slave device, receive a second device identifier transmitted by the slave device in relation to the in-band interrupt, use the second device identifier to select a first execution environment from the list, and interrupt the first execution environment responsive to the in-band interrupt.

In certain aspects, the second device identifier is allocated to one of a plurality of event sources in the slave device. The apparatus may include a controller configured to use the bus interface to write the second device identifier to a register in the slave device associated with a source of an event that triggers the in-band interrupt. The controller may be configured to allocate the first device identifier to the slave device during a first dynamic address allocation process. The controller may be configured to allocate the second device identifier to the slave device during a second dynamic address allocation process. The controller may be configured to use the serial bus to write the second device identifier to a register in the slave device associated with a first event source.

In one aspect, the controller may be configured to wake the first execution environment when the first execution environment is in a dormant state when the signaling corresponding to an in-band interrupt is detected. The apparatus may be operating in a sleep mode when the signaling corresponding to an in-band interrupt is detected, and a second execution environment is unaffected when the first execution environment is interrupted. A second execution environment may remain in a sleep mode when the first execution environment is interrupted.

In various aspects of the disclosure, a processor-readable storage medium has instructions stored thereon. The instructions, when executed by a processing circuit, may cause the processing circuit to detect signaling on the serial bus corresponding to an in-band interrupt asserted by a slave device, the slave device being associated with a first device identifier, receive a second device identifier transmitted by the slave device in relation to the in-band interrupt, use the second device identifier to select a first execution environment, and interrupt the first execution environment responsive to the in-band interrupt.

In various aspects of the disclosure, a method performed at a slave device coupled to a serial bus includes maintaining a first device identifier used to identify the slave device in transactions conducted over the serial bus, detecting a first event generated by a first event source, initiating an in-band interrupt on the serial bus after detecting the first event, and transmitting a second device identifier assigned to a source of the first event. The second device identifier may be provided to enable a master device to select an execution environment configured to respond of the first event.

In certain aspects, the first device identifier is received during a first dynamic address allocation procedure. The first dynamic address allocation procedure may be performed in accordance with an I3C protocol. The second device identifier may be written to a register of the slave device by the master device. The second device identifier may be preconfigured during manufacture or initiation of the slave device. The second device identifier may be received during a second dynamic address allocation procedure.

In some aspects, the source of the first event may be one of a plurality of event sources. Each event source may have an associated device identifier to be transmitted in in-band interrupt procedures.

In various aspects of the disclosure, a slave device has a bus interface operable as a bus master interface and adapted to couple the slave device to a serial bus, a plurality of event sources, and a list of device identifiers allocated to the slave device, the list associating each device identifier with one of the plurality of event sources. The bus interface may be configured to maintain a first device identifier used to identify the slave device in transactions conducted over the serial bus, detecting a first event generated by a first event source, initiating an in-band interrupt on the serial bus after detecting the first event, and transmitting a second device identifier assigned to a source of the first event. The second device identifier may be provided to enable a master device to select an execution environment configured to respond of the first event.

In various aspects of the disclosure, a processor-readable storage medium has instructions stored thereon. The instructions, when executed by a processing circuit, may cause the processing circuit to detect a first event generated by a first event source at a slave device, initiate an in-band interrupt on a serial bus after detecting the first event, and transmit a first device identifier assigned to a source of the first event. The first device identifier may be provided to enable a master device to select an execution environment configured to respond of the first event. A second device identifier may be used to identify the slave device in transactions conducted over the serial bus.

In various aspects, the second device identifier may be received during a first dynamic address allocation procedure. The first dynamic address allocation procedure may be performed in accordance with an I3C protocol. The first device identifier may be written to a register of the slave device by the master device. The first device identifier may be preconfigured during manufacture or initiation of the slave device. The first device identifier may be received during a second dynamic address allocation procedure. The source of the first event may be one of a plurality of event sources. Each event source may have an associated device identifier to be transmitted in in-band interrupt procedures.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates certain aspects of the timing relationship of start and stop signaling transmitted on the data and clock wires of a serial bus.

FIG. 4 illustrates certain aspects related to assignment of dynamic addresses in slave devices that may be adapted in accordance with certain aspects disclosed herein.

FIG. 5 illustrates certain aspects of a dynamic address allocation process performed by the bus master that may be adapted according to certain aspects disclosed herein.

FIG. 6 illustrates a system including slave devices that may produce events that may be communicated in accordance with certain aspects disclosed herein.

FIG. 7 illustrates an example of a system supporting in-band interrupts that may be adapted in accordance with certain aspects disclosed herein.

FIG. 8 illustrates a first message flow that illustrates processing of an in-band interrupt.

FIG. 9 illustrates an example of a system supporting in-band interrupts that enables automatic routing of the interrupt based on use of a dynamic address in accordance with certain aspects disclosed herein.

FIG. 10 illustrates a second message flow that illustrates automated processing of an in-band interrupt in accordance with certain aspects disclosed herein.

FIG. 11 is a block diagram illustrating an example of an apparatus employing a processing circuit that may be adapted according to certain aspects disclosed herein.

FIG. 12 is a flowchart illustrating a device that operates as a bus master in accordance with certain aspects disclosed herein.

FIG. 13 illustrates a first example of a hardware implementation for an apparatus adapted to respond to multiple dynamic addresses in accordance with certain aspects disclosed herein.

FIG. 14 is a flowchart illustrating a slave device that operates in accordance with certain aspects disclosed herein.

FIG. 15 illustrates a second example of a hardware implementation for an apparatus adapted to respond to multiple dynamic addresses in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a serial bus to connect processors with modems and other peripherals. The serial bus may be operated in accordance with specifications and protocols defined by a standards body. In one example, the serial bus may be operated in accordance I3C protocols, which define that each slave device is configured with a single, unique dynamic address. According to various aspects of the disclosure, a slave device may be provisioned with multiple dynamic addresses that can be assigned to sources of event notifications within the slave device and/or managed by the slave device. A bus master may map the addresses assigned to various sources of event notifications to execution environments such that event-related interrupts can be efficiently directed to one or more execution environments that are configured to handle and/or respond to the events. Accordingly, the dynamic addresses assigned to the sources of event notifications are used to address execution environments, and need not be used by a bus master to address the sources of event notifications. In one example, a slave device may respond to a primary dynamic address and may never receive communications directed to a one or more sources of event notifications. In some instances, a bus master may use dynamic addresses to address certain sources of event notifications to execution environments.

In one example, a slave device coupled to the serial bus may participate in a dynamic address allocation procedure to obtain its primary dynamic address after power-on or reset. A master device may then configure the slave device with dynamic addresses to serve as sources of event notifications. In some instances, a slave device may be configured to initiate or snoop additional dynamic address allocation procedures to obtain dynamic addresses for sources of event notifications.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (UPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

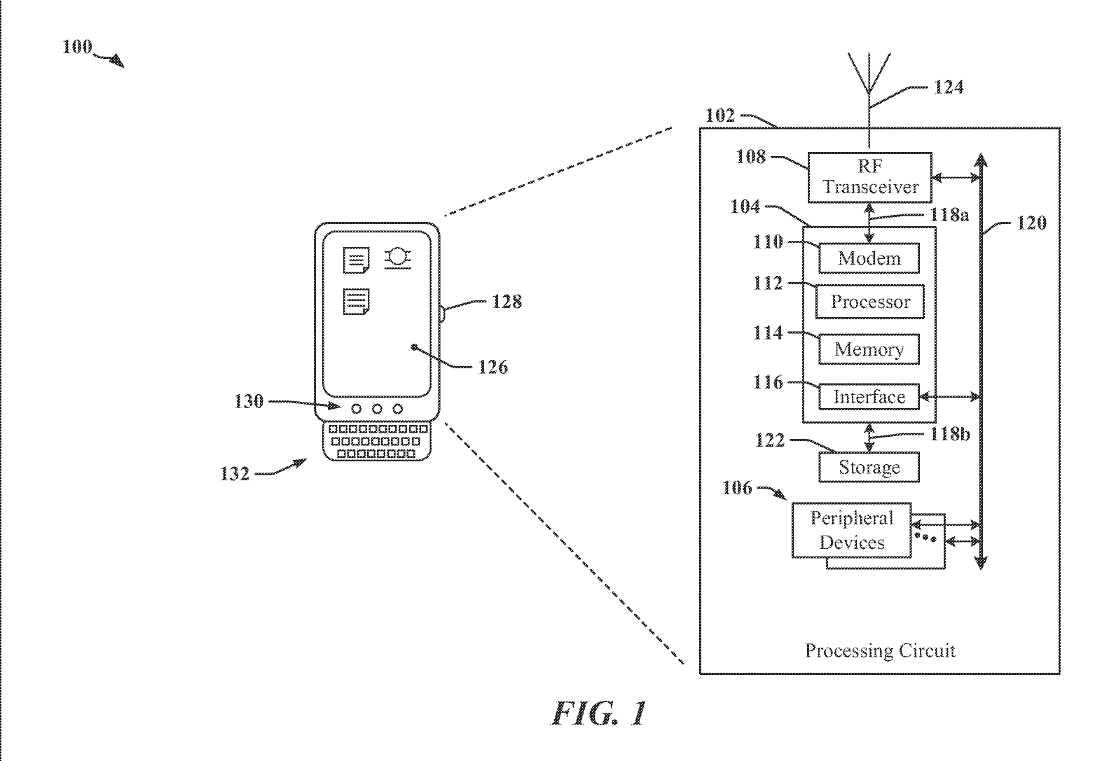

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100,

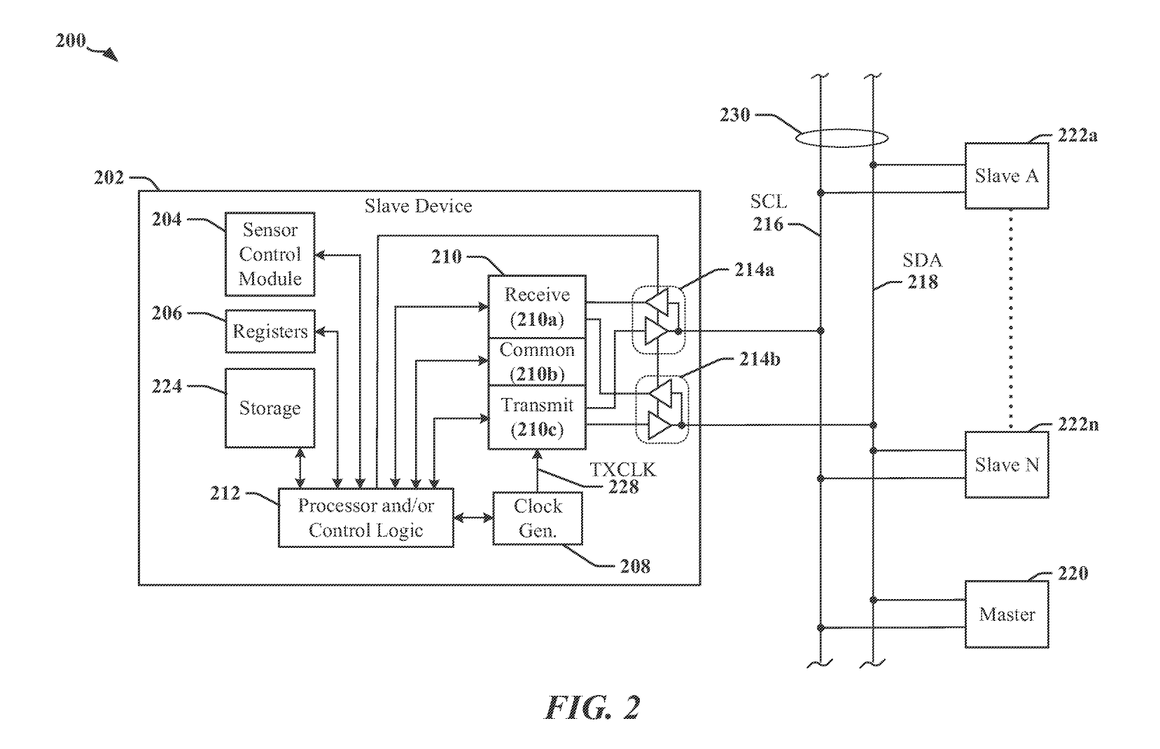

FIG. 2 illustrates certain aspects of an apparatus 200 that includes multiple devices 202, 220 and 222a-222n connected to a serial bus 230. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain protocols governing serial bus operation provide for more than one bus master 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a sensor control function 204. The sensor control function 204 may include circuits and modules that support an image sensor, and/or circuits and modules that control and communicate with one or more sensors that measure environmental conditions. The slave device 202 may include configuration registers or other storage 206, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits amid/or devices. In one example, the transmitter 210c encodes and transmits data based on timing provided by a clock generation circuit 208.

Two or more of the devices 202, 220 and/or 222a-222n may be adapted according to certain aspects and features disclosed herein to support a plurality of different communication protocols over a common bus, which may include the I2C protocol, and/or the I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. Protocols and standards may define direct current (DC) characteristics affecting certain signal levels associated with the serial bus 230, and/or alternating current (AC) characteristics affecting certain timing aspects of signals transmitted on the serial bus 230.

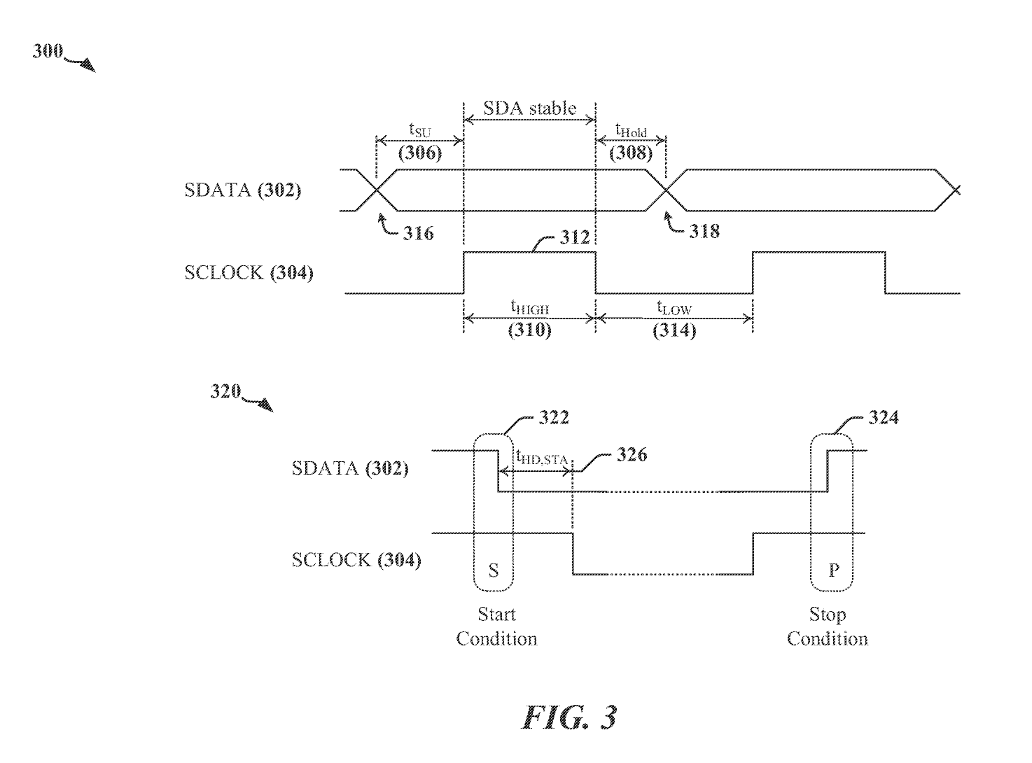

The timing diagrams 300 and 320 of FIG. 3 illustrate the relationship between SDATA 302 and SCLOCK 304 on a serial bus. The timing may apply to certain aspects of operation of the serial bus in accordance with I2C and/or I3C protocols. The first timing diagram 300 illustrates the timing relationship between SDATA 302 and SCLOCK 304 while data is being transferred on the serial bus. SCLOCK 304 provides a series of pulses that can be used to sample data in SDATA 302. The pulses (including the pulse 312, for example) may be defined as the time during which SCLOCK 304 is determined to be in a high logic state at a receiver. When SCLOCK 304 is in the high logic state during data transmission, data on SDATA 302 is required to be stable and valid; the state of SDATA 302 is typically not permitted to change when SCLOCK 304 is in the high logic state.

In one example, specifications for conventional I2C protocol implementations (which may be referred to as “I2C Specifications”) define a minimum duration 310 (t_{HIGH}) of the high period of the pulse 312 on SCLOCK 304. The I2C Specifications also define minimum durations for a setup time 306 (t_{SU}) before occurrence of the pulse 312, and a hold time 308 (t_{Hold}) after the pulse 312 terminates. The signaling state of SDATA 302 is expected to be stable during the setup time 306 and the hold time 308. The setup time 306 defines a maximum time period after a transition 316 between signaling states on SDATA 302 until the arrival of the rising edge of the pulse 312 on SCLOCK 304. The hold time 308 defines a minimum time period after the falling edge of the pulse 312 on SCLOCK 304 until a next transition 318 between signaling states on SDATA 302. The I2C Specifications also define a minimum duration 314 for a low period (t_{LOW}) for SCLOCK 304. The data on SDATA 302 is typically stable and/or can be captured for the duration 310 (t_{HIGH}) when SCLOCK 304 is in the high logic state after the leading edge of the pulse 312.

The I2C protocol provides for transmission of 8-bit data (bytes) and 7-bit addresses. A receiver may acknowledge transmissions by driving SDATA 302 to the low logic state for one clock period. The low signaling state represents an acknowledgement (ACK) indicating successful reception and a high signaling state represents a negative acknowledgement (NACK) indicating a failure to receive or an error in reception.

The second timing diagram 320 of FIG. 3 illustrates signaling states on SDATA 302 and SCLOCK 304 between data transmissions on a serial bus in which devices that communicate in accordance with conventional I2C protocols can coexist with devices that communicate in accordance with I3C and/or other protocols. A START condition 322 is defined to permit the current bus master to signal that data is to be transmitted. The START condition 322 occurs when SDATA 302 transitions from high to low while SCLOCK 304 is high. In an example involving transmissions according to I2C protocols, the I2C bus master initially transmits the START condition 322, which may be also be referred to as a start bit, followed by a 7-bit address of an I2C slave device with which it wishes to exchange data. The address is followed by a single bit that indicates whether a read or write operation is to occur. The addressed I2C slave device, if available, responds with an ACK bit. If no I2C slave device responds, the I2C bus master may interpret the high logic state of SDATA 302 as a NACK. The master and slave devices may then exchange bytes of information in frames, in which the bytes are serialized such that the most significant bit (MSB) is transmitted first. The transmission of the byte is completed when a STOP condition 324 is transmitted by the I2C master device. The STOP condition 324 occurs when SDATA 302 transitions from low to high while SCLOCK 304 is high. The I2C Specifications require that all transitions of SDATA 302 occur when SCLOCK 304 is low, and exceptions may be treated as a START condition 322 or a STOP condition 324.

The serial bus may be operated in accordance with a protocol that supports in-band interrupts. For example, the MIPI Alliance standard for I3C defines protocols that support prioritized interrupts, where priority levels are defined that control the order in which in-band interrupt requests are processed. The priority level defined for a slave corresponds to the value of the slave address or identifier. A lower slave address has a higher priority than a higher slave address.

An I3C slave device can initiate an in-band interrupt request after detecting a START condition 322 by transmitting its slave address in an arbitrated address header. When the serial bus is idle, the I3C slave may issue a START request by pulling SDATA 302 low. The primary master device detects the START request and completes a START condition 322 by driving SCLOCK 304 low. The slave device may then transmit its slave address on SDATA 302, followed by a RnW bit set to ‘1.’ The master may accept the in-band interrupt request by transmitting an ACK bit. One or more mandatory data bytes follow the accepted in-band interrupt request. The master device may determine a next action based on the content of the one or more mandatory data bytes.

Addressing Slaves Coupled to an I3C Bus

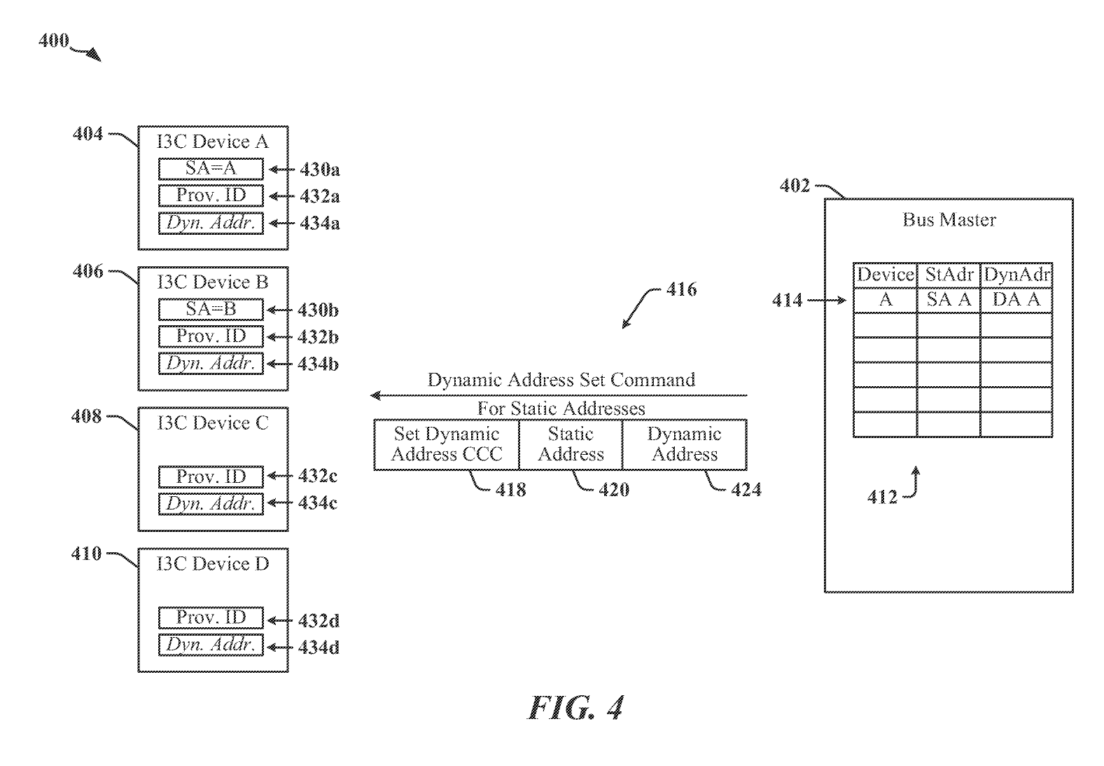

Certain protocols and specifications governing the operation of a serial bus define a scheme for addressing slaves coupled to the serial bus. With reference to FIG. 4, an I3C slave device 404, 406, 408, 410 may be initially provisioned with one of two types of identifier. Certain slave devices 404, 406 may be configured with a static address 430a, 430b, which may be an address defined for use on an I2C bus. Slave devices 404, 406, 408, 410 adapted for communication in accordance with DC protocols may be configured with a provisional identifier (provisional ID 432, 432b, 432c, 432d). A provisional ID 432a, 432b, 432c, 432d may be assigned to each slave device 404, 406, 408, 410 during system power-up or reset. The provisional ID 432a, 432b, 432c, 432d is used during a dynamic address allocation process when a bus master 402 assigns a dynamic address 434a, 434b, 434c, 434d to each slave device 404, 406, 408, 410. In normal operation, the slave devices 404, 406, 408, 410 are addressed using the dynamic address 434a, 434b, 434c, 434d. I3C protocols provide for a single, unique dynamic address 434a, 434b, 434c, 434d for each slave device 404, 406, 408, 410.

When performing the dynamic address allocation process, a bus master 402 may assign a dynamic address 434a or 434b to one or more of the slave devices 404, 406 that have been configured with a static address 430a, 430b. In one example, the bus master 402 may have a listing of static addresses 430a, 430b that may be configured in a slave device 404, 406 coupled to the serial bus. The bus master 402 may transmit a command sequence 416 addressed to a known static address 420. The command sequence 416 may include a command code 418 and a dynamic address value to be used by the slave devices 404, 406 that has a static address 430a, 430b corresponding to the addressed known static address 420. Upon receiving an acknowledgement from the addressed slave devices 404, 406, the bus master 402 may create an entry 414 in an address table 412 that associates the slave devices 404, 406 with static address 430a, 430b, and/or assigned dynamic address 424.

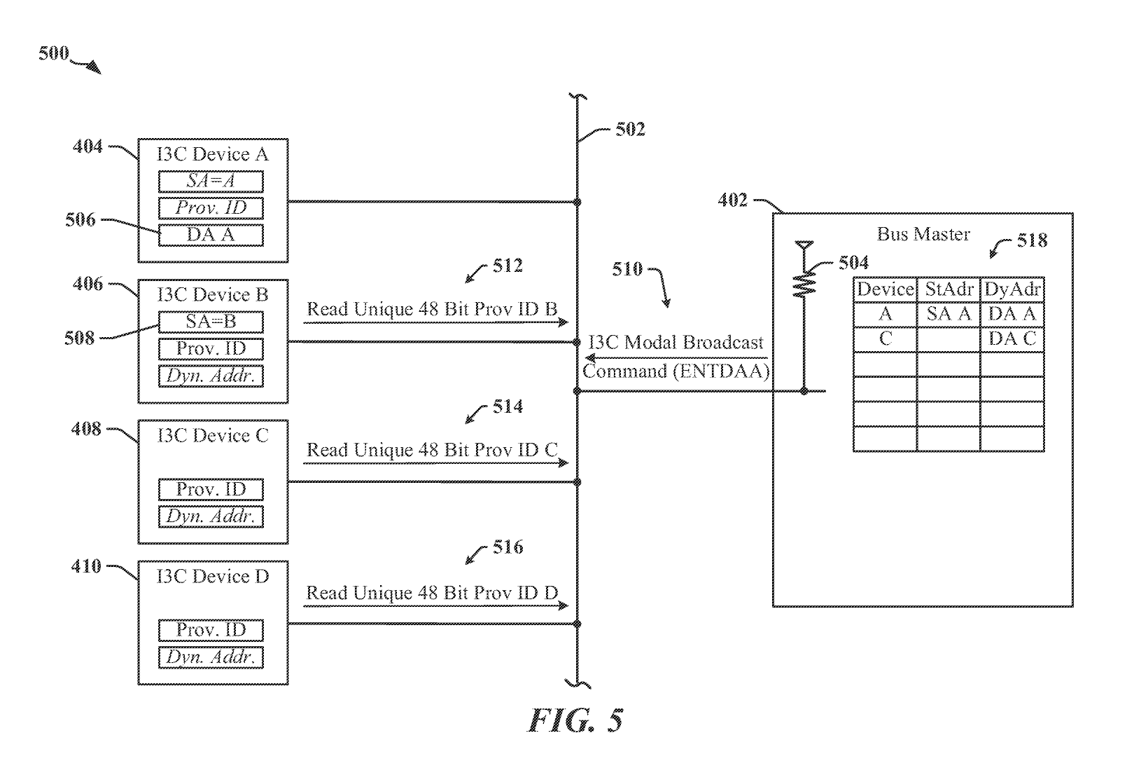

FIG. 5 illustrates certain aspects of a dynamic address allocation process performed by the bus master 402 that assigns dynamic addresses to slave devices 406, 408, 410 without static addresses. In one example, the bus master 402 may have assigned a dynamic address 506 to a first slave device 404, and may not have knowledge of a static address 508 configured in a second slave device 406. The bus master 402 may allocate dynamic addresses to the second slave device 406 and to other slave devices 408, 410 that do not have assigned static addresses by interrogating the provisional IDs of the slave devices 406, 408, 410. The master device may broadcast a command 510 that causes each of the slave devices 406, 408, 410 to respond by transmitting its respective provisional ID 512, 514, 516. The data line 502 of the serial bus may be driven by the slave devices 406, 408, 410 using an open-drain mode of transmission. A priority may be established based on the lowest address transmitted by the slave devices 406, 408, 410. In some examples, certain bits of the provisional IDs 512, 514, 516 may not be assessed when establishing priority and, according to certain aspects disclosed herein, these bits can be used to distinguish between alter egos. The bus master 402 may transmit a command sequence addressed to the provisional ID 512, 514, 516 with the lowest value (cf. the command sequence 416 of FIG. 4), where the command causes a receiver to write a dynamic address for the slave device 406, 408, 410 with the lowest value provisional ID 512, 514 or 516. This procedure repeats until a configured state has been accomplished where dynamic addresses have been assigned to all of the slave devices 404, 406, 408, 410 that are active on the serial bus. Assigned unique dynamic addresses may be are recorded in an address table 518 maintained by the bus master 402.

In a system that includes multiple slave devices 404, 406, 408, 410, an active bus master 402 that is currently in control of the serial bus initiates the dynamic address allocation process. Upon completion of the dynamic address allocation process, the slave devices 404, 406, 408, 410 engage in I3C transactions using the assigned dynamic address. The active bus master 402 may propagate its address table 518 to inactive bus masters. In some instances, an inactive bus master may build its own address table by snooping the dynamic address allocation process performed by the active bus master 402.

In some instances, an inactive slave device may not participate in the dynamic address allocation process. When the inactive slave device transitions to an active mode, a secondary dynamic address allocation process may be initiated through an in-band interrupt request issued by the newly-active slave device. The secondary dynamic address allocation process may be performed during a hot-join or hot-plug process as defined by bus protocols or specifications.

Addressing Slaves Coupled to an I3C Bus

The I3C specification defines that a single, unique dynamic address shall be allocated for each slave device, where all communications between the slave device and an I3C master use the single allocated dynamic address. In some instances, it may be desirable to address multiple groups of slave devices to broadcast data or commands, or for other purposes. In one example, a mobile communications device may provide cameras on two sides of the device to enable a user to independently capture forward facing images and backwards facing images. In another example, a mobile communications device may include a camera system having two or more imaging devices or cameras spaced apart on the same or different surfaces to enable capture of stereoscopic or three-dimensional (3-D) images. In the latter example, the two or more cameras may be operated concurrently, where it may be desirable or required that a baseband processor of the apparatus can transmit certain identical command and control information concurrently or simultaneously to both imaging devices.

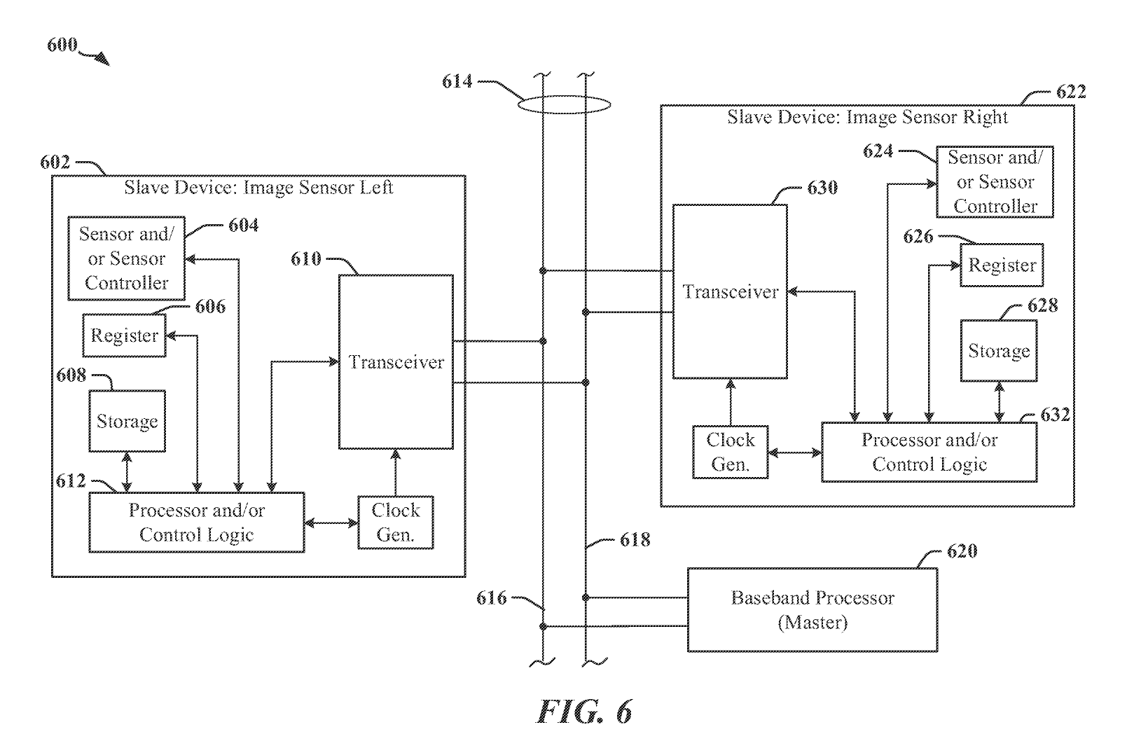

Certain aspects disclosed herein provide a capability to support one or more alter egos for a slave device. The slave device may be adapted to emulate one or more bus interfaces in addition to the physical bus interface defined by I3C protocols and specifications in order to obtain multiple dynamic addresses for the slave device. The utility of obtaining multiple dynamic addresses for a single slave device may be understood based on the examples illustrated in FIGS. 6-10.

FIG. 6 is a block schematic diagram illustrating certain aspects of an apparatus 600 that includes two imaging devices 602, 622, that each have an image sensor and/or sensor controller 604, 624, where the devices 602 622 are coupled as slaves to a serial bus 614. The apparatus 600 may be embodied in one or more of a mobile communication device, a mobile telephone, a camera, a mobile computing system, a smartphone, a notebook computer, a tablet computing device, a media player, a gaming device, a wearable computing device, an appliance, or the like. The apparatus 600 may include other slave devices (not shown) and a baseband processor 620 that serves as an I2C and/or I3C master on the serial bus 614, in one example, the apparatus may implement a 3-D or stereoscopic camera system with a left camera and a right camera providing separate views that are used to create a single 3-D image when combined. Each camera may be embodied in, or controlled by a slave device 602, 622 and may be coupled to the baseband processor 620 via the serial bus 614. For ease of manufacturing, both cameras may be identical to each other and may have the same static address.

The imaging devices 602, 622 may include sensor controllers 604, 624 that include, are coupled to, and/or manage respective image sensors. In addition, the imaging devices 602, 622 may include configuration registers 606, 626 and/or other storage devices 608, 628, processing circuits and/or control logic 612, 632, and transceivers 610, 630. Each of the processing circuits and/or control logic 612, 632 may include a processor such as a state machine, sequencer, signal processor, special-purpose processor, or general-purpose processor. The transceivers 610, 630 may include or control encoders, decoders, line drivers, line receivers, timing circuits, logic and storage circuits clock and data recovery circuits, and/or other devices.

In-Band Interrupts Initiated by Event Sources in I3C Slave Devices

Many conventional systems use dedicated general-purpose input/output (GPIO) pins for interrupt signals. An interrupt signal is typically generated by a hardware and/or software components to indicate the occurrence of an event that requires prompt, if not immediate, attention. A processor receives the interrupt and may suspend a currently processing task or function in order to activate an interrupt handler, which may also be referred to as an interrupt service routine (ISR). The interrupt handier may generate information that identifies the source of the interrupt, the type of interrupt and the priority of the interrupt. The interrupt handler may determine whether the interrupt is valid and/or whether the underlying event that triggered the interrupt is to be processed further, typically by an event handler. The interrupt handler may clear the interrupt at the event source 714. An event handler may be implemented in an application or other software function. In one example, an event handler may process information generated and/or provided by an interrupt handler during interrupt processing. The event handler may cause a bus interface to interrogate the event source 714 to obtain additional information, and/or to clear the source of the interrupt.

Interrupt signals may be asserted by a part of a system to alert other parts of the system. In some instances, an application executed by a first processor or control function may assert an interrupt to alert a different processor or control function. Physical interrupt signals are transmitted through GPIO pins to other devices. GPIO pins can increase cost of an IC and can consume significant area (real estate) on an IC.

I3C standards and protocols support an in-band interrupt capability whereby a slave device can alert a master device using In-Band Interrupt (IBI) signaling over the serial bus.

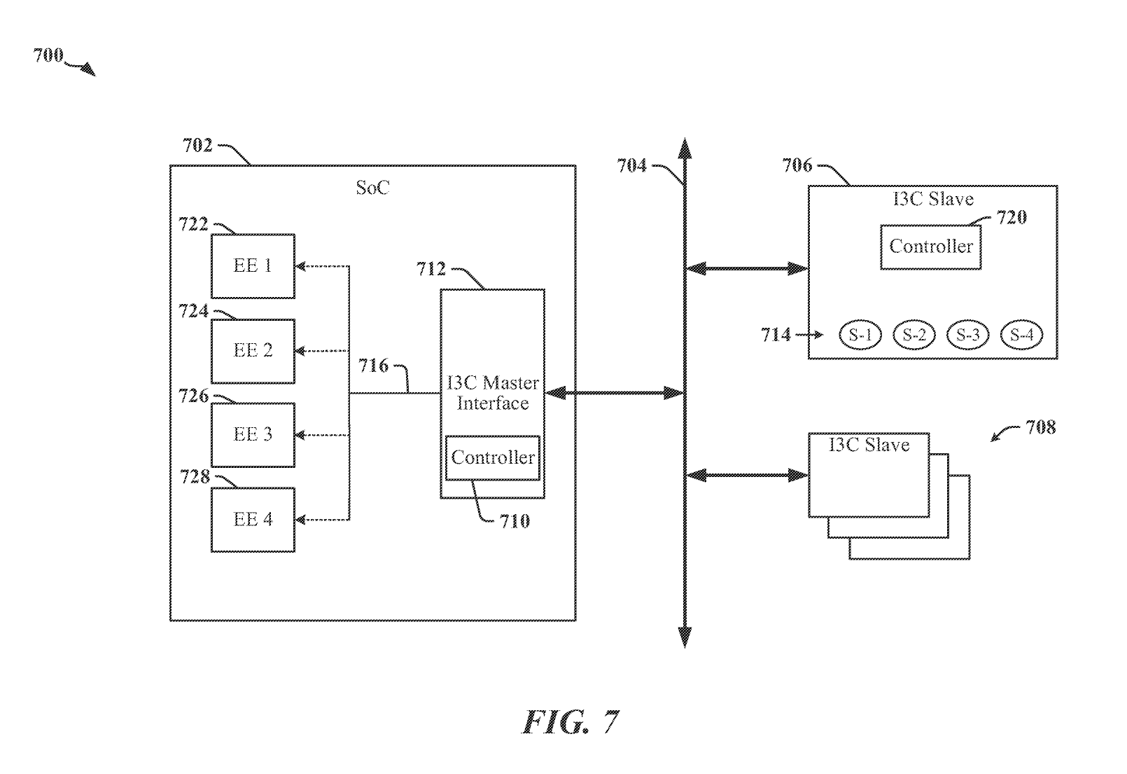

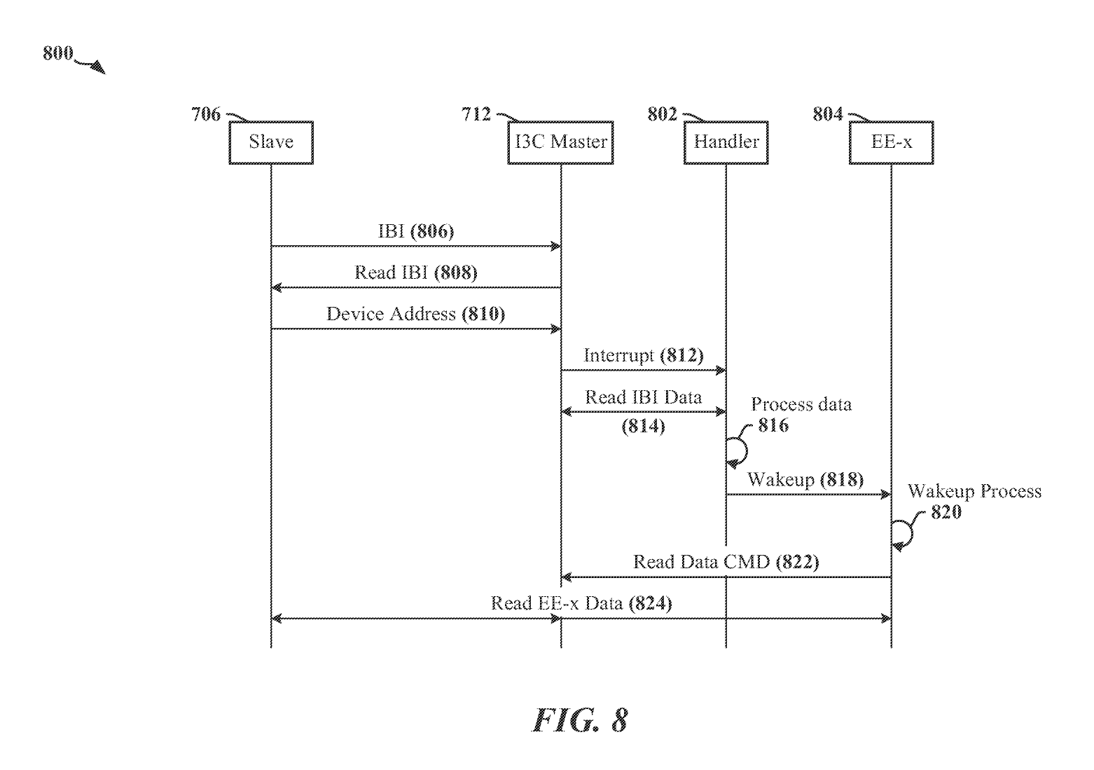

FIG. 7 illustrates an example of a system 700 that may be operated in accordance with I3C protocols, and which may support in-band interrupts. FIG. 8 is a message flow diagram 800 that illustrates processing of an in-band interrupt in the illustrated system 700. An SoC 702 includes a bus master interface 712 configured to couple the SoC 702 to a plurality of slave devices 706, 708 through a serial bus 704. The serial bus 704 may be operable in accordance with I3C protocols, for example. One or more of the slave devices 706, 708 may manage or be otherwise associated with a sensor that generates multiple events or multiple sensors each capable of generating events. In one example, the image sensors and/or sensor controllers 604, 624 and/or control logic 612, 632 illustrated in FIG. 6 may generate events related to light conditions, changes in captured image, available data, buffer condition, timing events etc. In another example, one or more of the slave devices 706, 708 may include, monitor or support sensors that, for example, provide information regarding environmental and/or operating conditions affecting a monitored apparatus.

In the example illustrated in FIG. 7, one slave device 706 includes four event sources 714. In some instances, one or more of the event sources 714 may operate independently of the other event sources 714. In some instances, two or more of the event sources 714 may operate in cooperation with one or more of the other event sources 714. Cooperating event sources 714 may produce related events concurrently, proximate in time with one another, or in a sequence determined by application or operating environment. The slave device 706 may include a controller 720 that monitors the event sources 714 in order to respond to events. For example, the controller 720 may initiate an IBI (IBI 806) to notify a bus master interface 712 operated in the SoC 702 that an event has occurred.

The SoC 702 may provide multiple execution environments (EEs 722, 724, 726, 728). An EL 722, 724, 726, 728 may be provided using some combination of dedicated and shared resources. In one example, a first block of memory may be dedicated for the use of one EL 722, 724, 726, 728, while a second block of memory may be shared between two or more EEs 722, 724, 726, 728. In another example, one or more EEs 722, 724, 726, 728 may have a dedicated processor or controller. In another example, two or more EEs 722, 724, 726, 728 may share a processor or controller using a real-time operating system or other resource-controlling mechanism. In many examples, the bus master interface 712 is shared or used by multiple EEs 722, 724, 726 and/or 728.

The bus master interface 712 may include or be coupled to a controller 710 adapted or configured to manage and/or respond to transmissions over the serial bus 704 in accordance with one or more protocols. The bus master interface 712 may respond to the IBI 806 by initiating an in-band interrupt handier (IBI handler 802). The IBI handler 802 may be resident in one of the EEs 722, 724, 726, 728, and may be initiated through signaling 716 and a transfer of information from the bus master interface 712. The signaling may include a wakeup signal, a message and/or an interrupt 812 transmitted by the bus master interface 712 to the EE 722, 724, 726, 728 that hosts the IBI handler 802. The bus master interface 712 may relay information included in the IBI 806 and/or a device address 810 provided in response to a read IBI command 808 issued during IBI processing. The IBI handler 802 may determine the underlying event source 714 that triggered the IBI 806, and the IBI handier 802 may identify an application that is associated with the underlying event source 714. The IBI handler 802 may cause the identified application to be dispatched, initiated or informed of the occurrence of the IBI. The identified application may then process event related information. In dispatching the identified application, the IBI handler 802 may wake or interrupt the EE 722, 724, 726, 728 that hosts the identified application. The IBI handler 802 and the identified application may be hosted by the same EE, 722, 724, 726 or 728 or by different EEs 722, 724, 726 and/or 728.

The message flow diagram 800 illustrates processing of an in-band interrupt (IBI 806) generated in response to occurrence of an event in the slave device 706. When the bus master interface 712 detects the IBI 806 initiated by the slave device 706, the bus master interface 712 may execute one or more transactions on the serial bus 704 in order to determine the source of the IBI 806. The bus master interface 712 is typically not expected to immediately know which slave device 706, 708 asserted the IBI 806, and a read IBI command 808 may be executed to cause the slave device 706 asserting the IBI 806 to respond by transmitting its device address 810. Having detected the IBI 806 and having determined the device address 810 of the initiator of the IBI 806 (here, the slave device 706), the bus master interface 712 may assert an interrupt 812 that interrupts an EE 722, 724, 726, 728 that hosts the IBI handler 802 used to handle the IBI 806 asserted on the serial bus 704. The IBI handler 802 may execute a read IBI data transaction 814 to obtain information assembled by the bus master interface 712 in relation to the IBI 806, including information identifying the source of the IBI 806 (e.g., the event source 714).

The IBI handler 802 may process data 816 including the data obtained during the read IBI data transaction 814. The IBI handler 802 may then determine an execution environment (EE-x 804) that handles events generated by the event source 714 and/or other initiator of the IBI 806. The IBI handler 802 may then wakeup 818 one or more EEs 722, 724, 726, 728, including the identified EE-x 804, as appropriate. The EE-x 804 may perform a wakeup process 820, if it was previously in idle or sleep mode. While responding to the interrupt 812 (and the IBI 806), EE-x 804 may issue one or more commands 822 to cause the bus master interface 712 to read data related to the IBI 806. The bus master interface 712 may initiate one or more transactions 824 involving the slave device 706, whereby data read from identified registers in the slave device are forwarded to EE-x 804.

In the example illustrated in FIGS. 7 and 8, the EE 722, 724, 726, 728 hosting the IBI handler 802 is activated or remains active in order to permit the IBI handler 802 to be executed. In many instances, the IBI handler 802 and an application identified by the IBI handler 802 to receive and process the event corresponding to the IBI 806 may reside on a different EE 722, 724, 726, 728. An IBI 806 may cause multiple EEs 722, 724, 726, 728 to be awakened, and may interrupt processing on the EE 722, 724, 726, 728 that hosts the IBI Handler 802, which can cause increased interrupt latency and power consumption.

Assigning Dynamic Addresses to Event Sources in I3C Slave Devices

According to certain aspects disclosed herein, a slave device that is configured to communicate in accordance with I3C protocols and specifications may be adapted to maintain one or more dynamic addresses for use in in-band interrupt procedures. The one or more dynamic addresses may be addresses that are different from a primary dynamic address used to address the slave device in transactions conducted over the serial bus. Certain dynamic addresses may be used solely for identification of an event source that initiated or triggered an in-band interrupt procedure. Some dynamic addresses may be used for identification of an event source that initiated or triggered an in-band interrupt procedure, and/or for addressing registers associated with the event source.

The dynamic addresses may be configured by a bus master that assigns addresses to source of events. The bus master may initially dynamically assign a unique address for a slave device that includes one or more sources of events. In some instances, the slave device may already have a unique address assigned during initialization or configured during manufacture or assembly. In one example, the bus master may write dynamic addresses to registers that are associated with, and/or accessible to, sources of events, where the registers are reserved for the purpose of maintain dynamic address information. In another example, the bus master may assign dynamic addresses to the slave device during an address allocation procedure, where the slave requests addresses for one or more sources of events within the slave.

A dynamic address assigned to a source of events may be used by a slave device to identify the source of events during an in-band interrupt procedure. A master device handling the in-band interrupt may use the dynamic address provided during an in-band interrupt procedure to interrupt an execution environment assigned to handle the source of events associated with the dynamic address provided during in-band interrupt processing. A bus master interface may be adapted to automatically direct the interrupt to an appropriate execution environment without involving or notifying other unrelated execution environments, interrupt handlers and/or controllers. When an SoC, for example, is operating in a power conservation mode with controllers and/or execution environments in sleep mode, the arrival of an in-band interrupt with a dynamic address identifying the source of the event may be handled with minimum disturbance to the power conservation mode, since only the execution environment designated to handle the underlying event need be awake or awakened. The dynamic address assigned to a source of events may be used to address execution environments in the master device rather than addressing the source of events in the slave device.

Dynamic addresses assigned to sources of events may also be used to directly access registers associated with the sources of events during normal bus operations. In certain implementations, dynamic addresses assigned to sources of events are not used to directly access registers associated with the sources of events during normal bus operations.

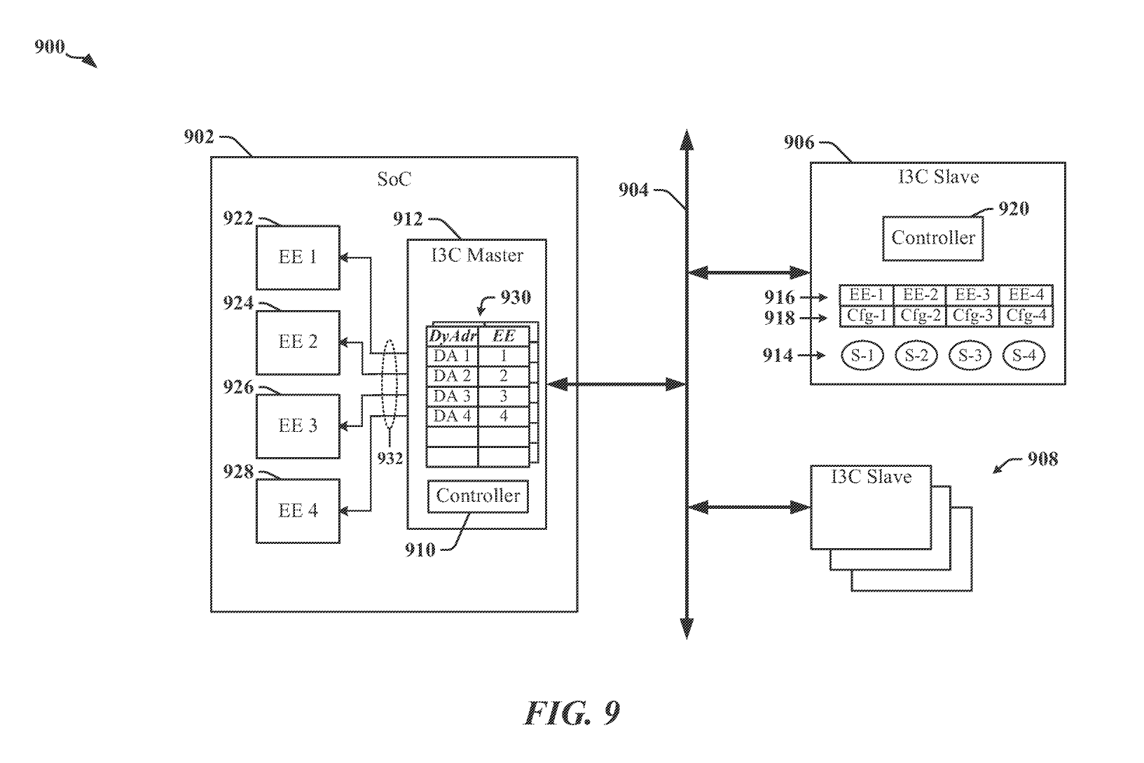

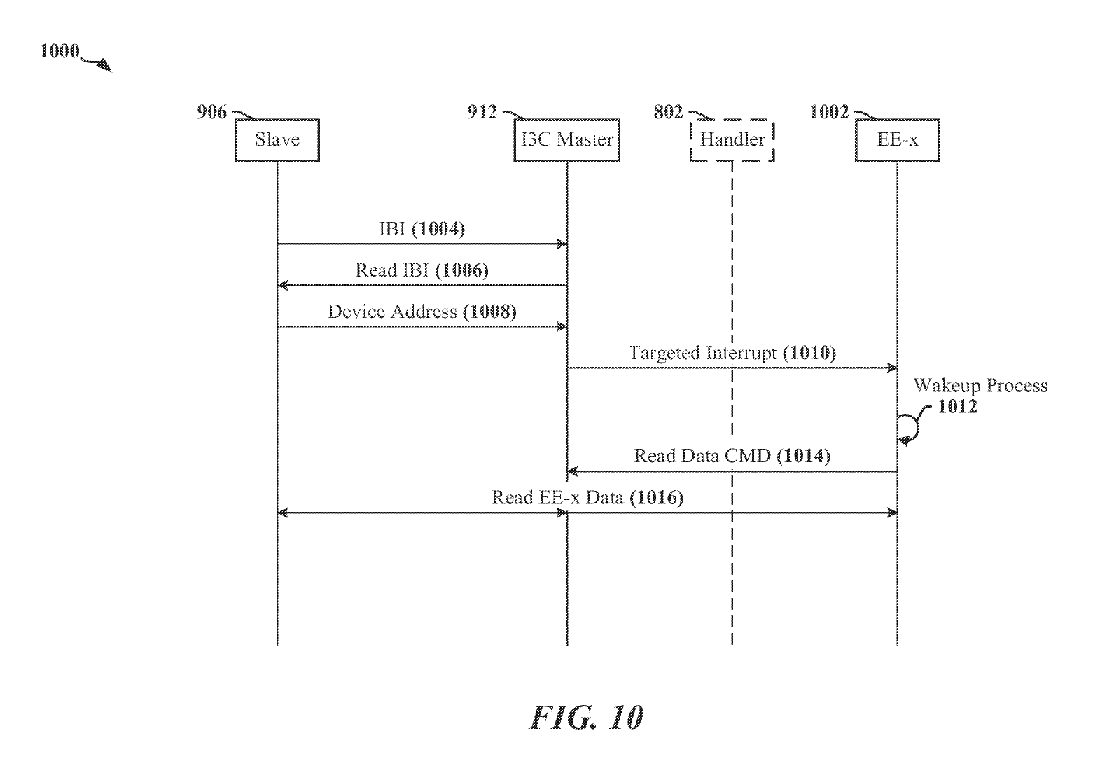

FIG. 9 illustrates an example of a system 900 in which an SoC 902 and slave device 906 have been adapted in accordance with certain aspects disclosed herein. FIG. 10 is a message flow diagram 1000 that illustrates processing of an in-band interrupt in the system 900. The SoC 902 may provide multiple execution environments (EEs 922, 924, 926, 928) in which an event-handling application may reside. An EE 922, 924, 926, 928 may be provided using some combination of dedicated and shared resources. In one example, a first block of memory may be dedicated for the use of one EE 922, 924, 926, 928, while a second block of memory may be shared between two or more EEs 922, 924, 926, 928. In another example, one or more EEs 922, 924, 926, 928 may have a dedicated processor or controller. In another example, two or more EEs 922, 924, 926, 928 may share a processor or controller using a real-time operating system or other resource-controlling mechanism. In many examples, the bus master interface 912 is shared by multiple EEs 922, 924, 926 and/or 928.

The SoC 902 includes a bus master interface 912 configured to couple the SoC 902 to a plurality of slave devices 906, 908 through a serial bus 904. The serial bus 904 may be operable in accordance with I3C protocols. One or more of the slave devices 906, 908 may manage or be otherwise associated with a sensor that generates multiple events or multiple sensors that each generate one or more events. In one example, the image sensors and/or sensor controllers 604, 624 and/or control logic 612, 632 illustrated in FIG. 6 may generate events related to light conditions, changes in captured image, available data, buffer condition, timing events etc. In another example, one or more of the slave devices 906, 908 may include, monitor or support multiple sensors that, for example, provide information regarding environmental and/or operating conditions affecting a monitored apparatus.

In the example illustrated in FIG. 9, one slave device 906 includes four event sources 914. In some instances, one or more of the event sources 914 may operate independently of the other event sources 914. In some instances, two or more of the event sources 914 may operate in cooperation with one or more of the other event sources 914. Certain cooperating event sources 914 may produce related events concurrently, proximate in time with one another, or in a sequence determined by application or operating environment. The slave device 906 may include a controller 920 that monitors the event sources 914 in order to respond to events. The controller 920 may initiate an in-band interrupt to notify the bus master interface 912 that an event has occurred.

The slave device 906 includes storage that may be used to maintain dynamic addresses 916 and related configuration information 918 for each of the event sources 914, in one example, the slave device may assign addressable registers to store dynamic addresses 916 and the related configuration information 918. The registers may be directly accessible through the serial bus 904, permitting the bus master interface 912 to preconfigure the dynamic addresses 916 and related configuration information 918. In some implementations, one or more tables in the slave device 906 that hold the dynamic addresses 916 and related configuration information 918 may not be directly accessible through the serial bus 904, and the dynamic addresses 916 and related configuration information 918 may be configured through a dynamic address allocation process. In some instances, a protocol may be defined that enables the bus master interface 912 to provide information used by the slave device 906 to populate the dynamic addresses 916 and related configuration information 918. The configuration information 918 may determine, for example, whether an interrupt associated with a corresponding dynamic address 916 is enabled.

The bus master interface 912 may include one or more tables 930 that defines relationships between dynamic addresses allocated to event sources 914 with corresponding execution environments 922, 924, 926, 928 designated to handle events from the event sources 914. The tables 930 may include entries for multiple slave devices 906, 908, and for multiple event sources 914 within one or more slave devices 906, 908. The bus master interface 912 may participate in allocation of the dynamic addresses to event sources 914. Address allocation may be performed as part of a protocol-governed address allocation procedure. In some instances, an application may assign addresses to event sources 914. In some instances, addresses may be assigned during manufacture and/or system configuration and/or initialization.

The bus master interface 912 may be configured to automatically respond to an IBI 1004 by signaling an execution environment 922, 924, 926, 928 that hosts a corresponding event-handling application. In some instances, a controller 910 that manages operation of the bus master interface 912 may be employed to provide an enhanced or automated response to the IBI 1004. In some instances, the bus master interface 912 may be configured to identify the source of an IBI 1004 and to assert one of a plurality of internal interrupts 932 in order to directly interrupt the EE 922, 924, 926, 928 that hosts an event-handling application associated with the underlying event source 914. The event-handling application may then process event-related information.

The dynamic addresses 916 assigned to corresponding event sources 914 are effectively used to address corresponding EEs 922, 924, 926, 928. In one example, the controller 910 in the bus master interface 912 interrogates the slave device 906 that asserted the IBI 1004 by causing the bus master interface 912 to issue a Read IBI command 1006 or other transaction. The controller 910 uses the device address 1008 returned by the slave device 906 as an index to the tables 930, and thereby to identify an EE 922, 924, 926, 928 to handle the event signaled by the IBI 1004. The controller 910 may then assert one or more internal interrupts 932 as needed to notify the event-handling application associated with the underlying event source 914, and/or another application, that an event has been signaled.

The message flow diagram 1000 illustrates processing of the IBI 1004 generated in response to occurrence of an event in the slave device 906. When the bus master interface 912 detects the IBI 1004 initiated by the slave device 906, the bus master interface 912 may execute one or more transactions on the serial bus 904 in order to determine the source of the IBI 1004. For example, the bus master interface 912 may transmit a read IBI command 1006, which includes transmittal of a code (e.g., ‘7E’) to the slave device 906, such that the slave device 906 responds with a highest priority address associated with an event source 914 that has an event pending. Higher priority addresses typically have lower values. According to one aspect, the controller 920 in the slave device 906 may select a dynamic address 916 that can be used to identify an execution environment 922, 924, 926, 928 in the SoC 902 (i.e., EE-x 1002) that is designated to handle events generated by the source of the IBI 1004. The selected dynamic address 916 is transmitted as the device address 1008 in response to the read IBI command 1006.

The bus master interface 912 may use the received dynamic address 916 to look up one or more tables 930 to identify an execution environment 922, 924, 926, 928 in the SoC 902 that is designated to handle events from the event source 914 that triggered the IBI 1004. An IBI handier 802 executed by a main processor or other EE 922, 924, 926, 928 is not needed to identify the EE 922, 924, 926, 928. Having detected the IBI 1004 and having identified the EE 922, 924, 926, 928 in the SoC 902 that is designated to handle events from the event source 914 that triggered the IBI 1004, the bus master interface 912 may assert a targeted interrupt 1010 (e.g., one of the internal interrupts 932) that interrupts the identified EE 922, 924, 926 or 928, in some instances, the targeted interrupt 1010 may cause the identified EE 922, 924, 926, 928 to perform a wakeup process 1012. While processing the targeted interrupt 1010, an event-handling application in the EE-x 1002 may issue one or more commands 1014 that cause the bus master interface 912 to read data related to the IBI 1004. The bus master interface 912 may initiate one or more transactions 1016 involving the slave device 906, whereby data read from identified registers in the slave device are forwarded to the EE-x 1002.

Examples of Processing Circuits and Methods

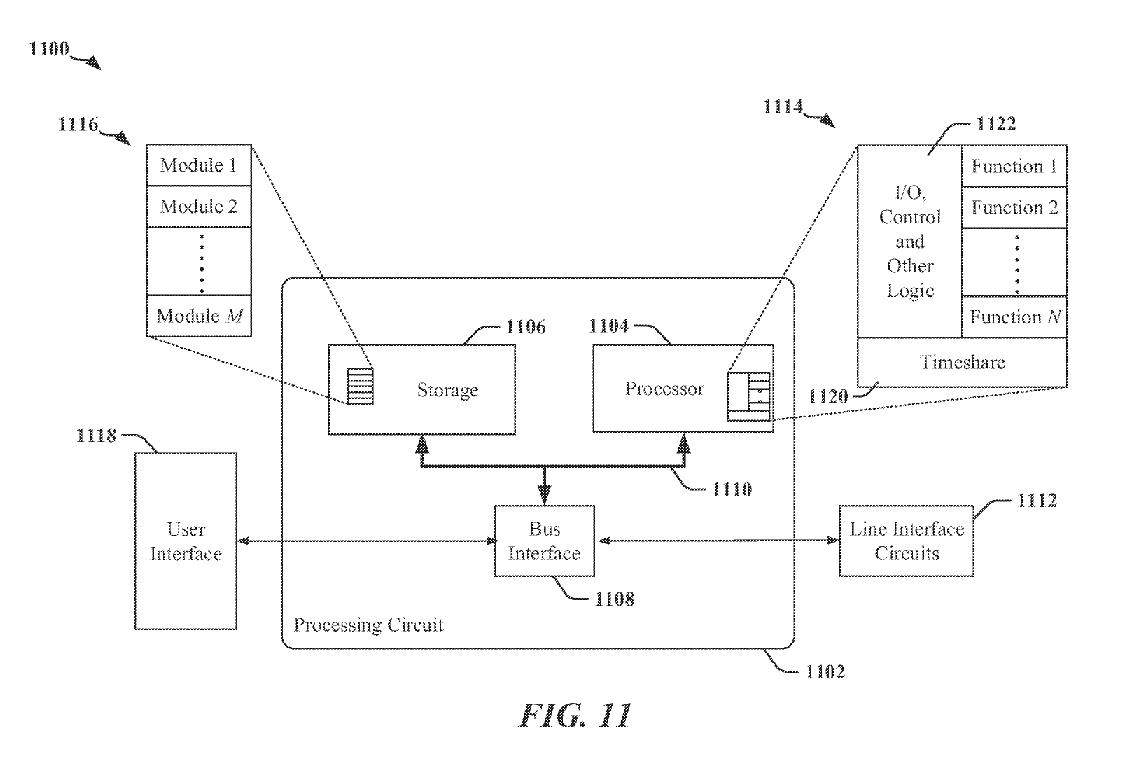

FIG. 11 is a diagram illustrating an example of a hardware implementation for an apparatus 1100 employing a processing circuit 1102 that may be configured to perform one or more functions disclosed herein. In accordance with various aspects of the disclosure, an element, or any portion of an element, or any combination of elements as disclosed herein may be implemented using the processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured w perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112. A transceiver 1112 may be provided for each networking technology supported by the processing circuit. In some instances, multiple networking technologies may share some or all of the circuitry or processing modules found in a transceiver 1112. Each transceiver 1112 provides a means for communicating with various other apparatus over a transmission medium. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement any one of the methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as the transceiver 1112, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to the transceiver 1112, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112, and device drivers, for example. To support the performance of multiple functions, the one or more processors 1104 may be configured to provide a multitasking environment and/or a plurality of execution environments. Each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

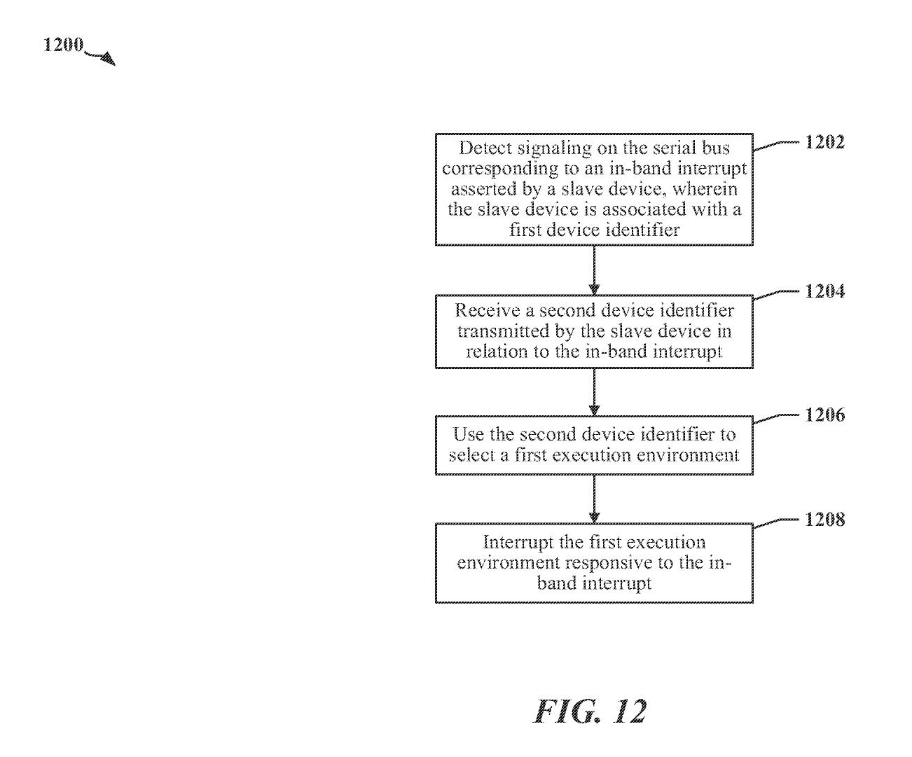

FIG. 12 is a flowchart 1200 of a method that may be performed at an SoC coupled to a serial bus through a bus interface. The bus interface may be configured to operate as a master device. In one example, the bus interface may be configured to operate in accordance with I3C protocols.

At block 1202, the bus interface may detect signaling on the serial bus corresponding to an in-band interrupt asserted by a slave device. The slave device may be associated with a first device identifier. The first identifier may be used in communications using the serial bus and involving the slave device.

At block 1204, the bus interface may receive a second device identifier transmitted by the slave device in relation to the in-band interrupt.

At block 1206, the bus interface may use the second device identifier to select a first execution environment.

At block 1208, the bus interface may interrupt the first execution environment responsive to the in-band interrupt.

In certain examples, the slave device includes a plurality of event sources. The bus interface may assign device identifiers to the plurality of event sources to be used for identifying sources of events generated by the plurality of event sources. The bus interface may maintain a list that associates an execution environment with each device identifier assigned to an event source. The first execution environment may be selected using the list. The bus interface may write the device identifiers to registers in the slave device associated with the plurality of event sources. The bus interface may use the first device identifier when writing the device identifiers. The first device identifier may be allocated to the slave device during a first dynamic address allocation process. In some examples, the second device identifier may be assigned or allocated to the slave device during a second dynamic address allocation process. In other examples, the bus interface may write the second device identifier to a register associated with a first event source in the slave device.

In one example, the master device may be operating in a sleep mode when the signaling corresponding to an in-band interrupt is detected. The first execution environment may he awakened prior to, or during interruption responsive to the in-band interrupt. The master device and/or a plurality of execution environments may be operating in a sleep mode when the signaling corresponding to an in-band interrupt is detected. In some instances, a second execution environment is unaffected when the first execution environment is interrupted.

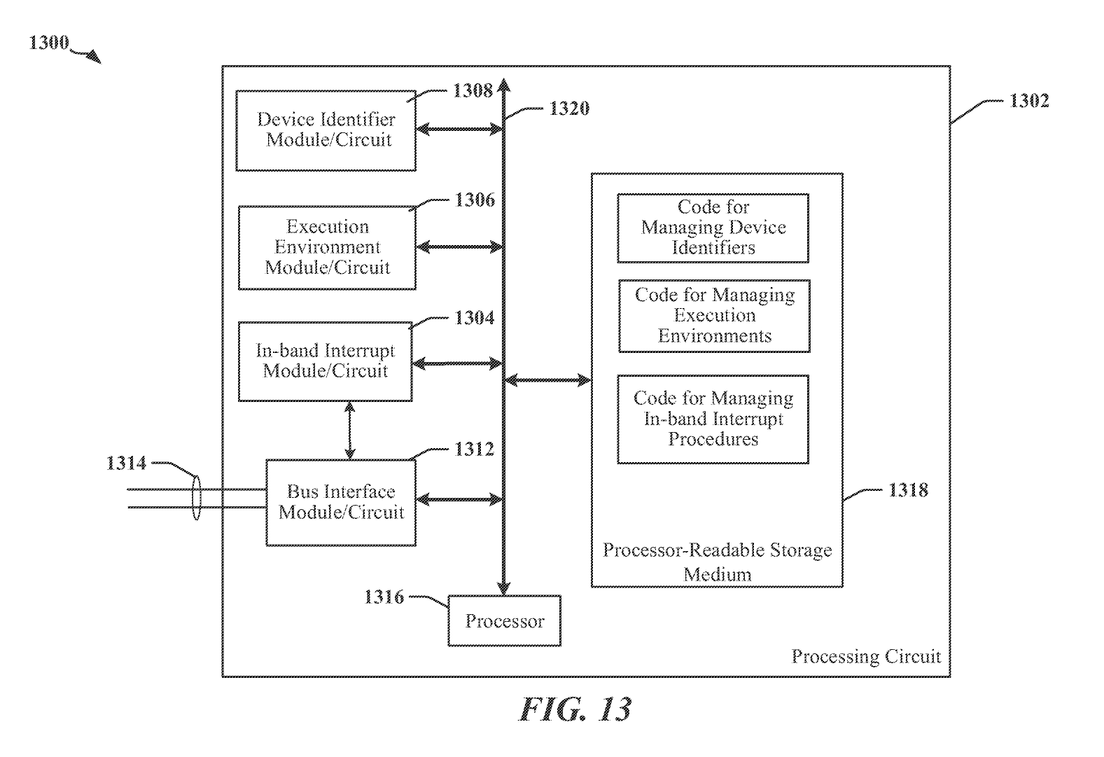

FIG. 13 is a diagram illustrating a simplified example of a hardware implementation for an apparatus 1300 employing a processing circuit 1302. In one example, the apparatus may be implemented in an SoC. The processing circuit 1302 typically has a controller or processor 1316 that may be implemented using one or more microprocessors, microcontrollers, digital signal processors, sequencers and/or state machines. The processing circuit 1302 may include a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the controller or processor 1316, the modules or circuits 1304, 1306 and 1308, and the computer-readable storage medium 1318. The apparatus may have a bus interface 1312 adapted for serial communication over two or more wires 1314. The bus 1320 may also link various other circuits such as timing sources, peripherals, voltage regulators, and power management circuits, which are well known in the art, and therefore, will not be described any further.

The processor 1316 is responsible for general processing, including the execution of software, code and/or instructions stored on the computer-readable storage medium 1318. The computer-readable storage medium 1318 may include a non-transitory storage medium. The software, when executed by the processor 1316, causes the processing circuit 1302 to perform the various functions described supra for any particular apparatus. The computer-readable storage medium 1318 may be used for storing data that is manipulated by the processor 1316 when executing software. The processing circuit 1302 further includes at least one of the modules 1304, 1306 and 1308. The modules 1304, 1306 and 1308 may be software modules running in the processor 1316, resident/stored in the computer-readable storage medium 1318, one or more hardware modules coupled to the processor 1316, or some combination thereof. The modules 1304, 1306 and 1308 may include microcontroller instructions, state machine configuration parameters, or some combination thereof.

In one configuration, the apparatus 1300 includes modules and/or circuits 1308 configured to manage device identifiers, and that may map device identifiers associated with evet sources to execution environments. The apparatus 1300 may include modules and/or circuits 1306 configured to manage and configure execution environments maintained within the apparatus 1300. The apparatus 1300 may include modules and/or circuits 1304 configured to respond to in-band interrupts. The apparatus 1300 may include modules and/or circuits 1308 configured to obtain dynamic addresses from one or more dynamic address allocation procedures including, in some implementations, a dynamic address allocation procedure performed after reset or device power-on. The apparatus may communicate over a bus 1320 using interface modules and circuits operated in accordance with an I3C protocol.

In one example, the apparatus 1300 includes a bus interface 1312 operable as a bus master interface and adapted to couple the apparatus to a serial bus, a plurality of execution environments, each configured to perform one or more functions independently of another execution environment, and a list of device identifiers allocated to a slave device. The list may identify associations between device identifiers and execution environments. The bus interface 1312 may be configured to detect signaling on the serial bus corresponding to an in-band interrupt asserted by the slave device, receive a second device identifier transmitted by the slave device in relation to the in-band interrupt, use the second device identifier to select a first execution environment from the list, and interrupt the first execution environment responsive to the in-band interrupt.

In certain examples, the second device identifier is allocated to one of a plurality of event sources in the slave device. The processor 1312 may be configured to use the bus interface 1312 to write the second device identifier to a register in the slave device associated with a source of an event that triggers the in-band interrupt. The processor 1312 may be configured to allocate the first device identifier to the slave device during a first dynamic address allocation process. The processor 1312 may be configured to allocate the second device identifier to the slave device during a second dynamic address allocation process. The processor 1312 may be configured to use the serial bus to write the second device identifier to a register in the slave device associated with a first event source. The processor 1312 may be configured to wake the first execution environment when the first execution environment is in a dormant state when the signaling corresponding to an in-band interrupt is detected. The apparatus 1300 may be operating in a sleep mode when the signaling corresponding to an in-band interrupt is detected. A second execution environment may be unaffected when the first execution environment is interrupted. A second execution environment may remain in a sleep mode when the first execution environment is interrupted.

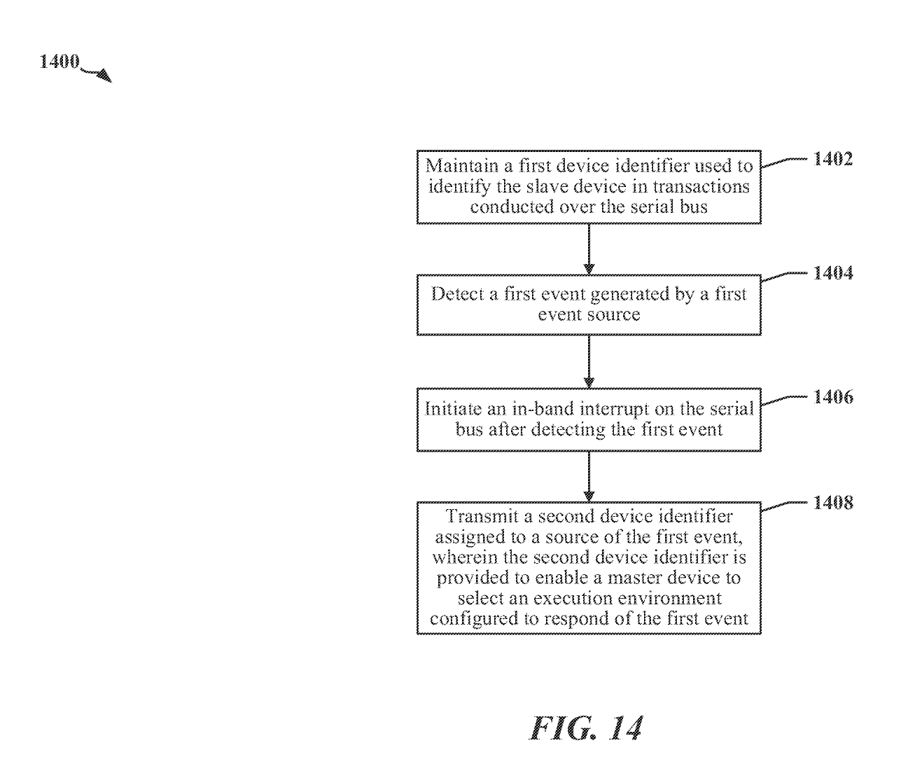

FIG. 14 is a flowchart 1400 illustrating certain operations of a slave device in accordance with certain aspects disclosed herein.

At block 1402, the application processor may maintain a first device identifier used to identify the slave device in transactions conducted over a serial bus.

At block 1404, the application processor may detect a first event generated by a first event source.

At block 1406, the application processor may initiate an in-band interrupt on the serial bus after detecting the first event.

At block 1408, the application processor may transmit a second device identifier assigned to a source of the first event. The second device identifier may be provided to enable a master device to select an execution environment configured to respond of the first event.

In certain examples, the first device identifier may be received during a first dynamic address allocation procedure. The first dynamic address allocation procedure may be performed in accordance with an I3C protocol. The second device identifier may be written to a register of the slave device by a master device. The second device identifier may be preconfigured during manufacture or initiation of the slave device. The second device identifier may be received during a second dynamic address allocation procedure.

In one example, the source of the first event is one of a plurality of event sources. Each event source may have an associated device identifier to be transmitted in in-band interrupt procedures.

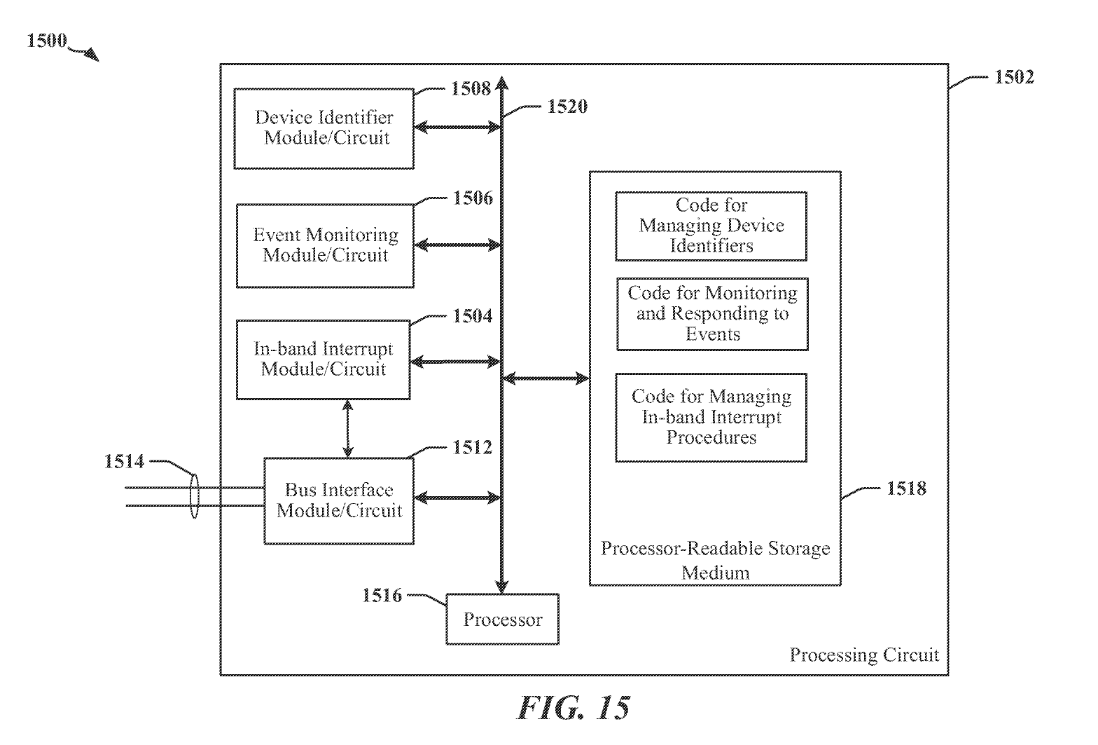

FIG. 15 is a diagram illustrating a simplified example of a hardware implementation for an apparatus 1500 employing a processing circuit 1502. The processing circuit 1502 typically has a controller or processor 1516 that may be implemented using one or more microprocessors, microcontrollers, digital signal processors, sequencers and/or state machines. The processing circuit 1502 may have a bus architecture, represented generally by the bus 1520. The bus 1520 may include any number of interconnecting buses and bridges depending on the specific application of the processing circuit 1502 and the overall design constraints. The bus 1520 links together various circuits including one or more processors and/or hardware modules, represented by the controller or processor 1516, the modules or circuits 1504, 1506 and 1508, and the computer-readable storage medium 1518. The apparatus may have a bus interface 1512. The bus 1520 may also link various other circuits such as timing sources, peripherals, voltage regulators, and power management circuits, which are well known in the art, and therefore, will not be described any further.

The processor 1516 is responsible for general processing, including the execution of software, code and/or instructions stored on the computer-readable storage medium 1518. The computer-readable storage medium 1518 may include a non-transitory storage medium. The software, when executed by the processor 1516, causes the processing circuit 1502 to perform the various functions described supra for any particular apparatus. The computer-readable storage medium 1518 may be used for storing data that is manipulated by the processor 1516 when executing software. The processing circuit 1502 further includes at least one of the modules 1504, 1506 and 1508. The modules 1504, 1506 and 1508 may be software modules running in the processor 1516, resident/stored in the computer-readable storage medium 1518, one or more hardware modules coupled to the processor 1516, or some combination thereof. The modules 1504, 1506 and 1508 may include microcontroller instructions, state machine configuration parameters, or some combination thereof.

In one configuration, the apparatus 1500 includes modules and/or circuits 1508 configured to manage device identifiers, including mapping or associating device identifiers with event sources. The apparatus 1500 may include modules and/or circuits 1506 configured to monitor event sources to determine when an event occurs that is to be communicated using an in-band interrupt. The apparatus 1500 may include modules and/or circuits 1504 configured to generate in-band interrupts and respond to and/or manage in-band interrupt procedures. In-band interrupts may be used to communicate event information to a master device. In-band interrupts may be used for dynamic address allocation procedures. The apparatus may communicate over a bus using interface modules and circuits operated in accordance with an I3C protocol.

In certain examples, the apparatus 1500 includes a bus interface 1512 configurable to operate as a bus master, and adapted to couple the apparatus to a serial bus 1514. The processor 1516 may be configured to detect a first event generated by a first event source at a slave device, initiate an in-band interrupt on the serial bus 1514 after detecting the first event, and transmit a first device identifier assigned to a source of the first event, the first device identifier being provided to enable a master device to select an execution environment configured to respond of the first event. A second device identifier may be used to identify the slave device in transactions conducted over the serial bus 1514. The second device identifier may be received during a first dynamic address allocation procedure. The first dynamic address allocation procedure may be performed in accordance with an I3C protocol. The first device identifier may be written to a register of the slave device by the master device. The first device identifier may be preconfigured during manufacture or initiation of the slave device. The first device identifier is received during a second dynamic address allocation procedure.

In some examples, the source of the first event is one of a plurality of event sources, and each event source may be associated with a device identifier that is transmitted during in-band interrupt procedures.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a master device coupled to a serial bus, comprising:
detecting signaling on the serial bus corresponding to an in-band interrupt asserted by a slave device, wherein each device communicatively coupled to the serial bus is uniquely identified in transactions on the serial bus by a device identifier, and wherein the slave device is identified as a source of the in-band interrupt by a first device identifier transmitted by the slave device during processing of the in-band interrupt;
receiving a second device identifier transmitted by the slave device as its device address in a response to a command related to the in-band interrupt;
using the second device identifier to select a first execution environment; and
interrupting the first execution environment responsive to the in-band interrupt.

2. The method of claim 1, wherein the slave device includes a plurality of event sources, further comprising:
assigning device identifiers to the plurality of event sources to be used for identifying sources of events generated by the plurality of event sources; and
maintaining a list that associates an execution environment with each device identifier assigned to an event source,
wherein the first execution environment is selected using the list.

3. The method of claim 2, wherein assigning the device identifiers to the plurality of event sources comprises:
writing the device identifiers to registers associated with the plurality of event sources.

4. The method of claim 2, wherein assigning the device identifiers to the plurality of event sources comprises:
allocating the first device identifier to the slave device during a first dynamic address allocation process; and
allocating the second device identifier to the slave device during a second dynamic address allocation process,
wherein at least one dynamic address allocation process is performed in accordance with an I3C protocol.

5. The method of claim 2, wherein assigning the device identifiers to the plurality of event sources comprises:
allocating the first device identifier to the slave device during a first dynamic address allocation process; and
using the serial bus to write the second device identifier to a register in the slave device associated with a first event source.

6. The method of claim 1, wherein the master device is operating in a sleep mode when the signaling corresponding to the in-band interrupt is detected, and wherein interrupting the first execution environment includes:
waking the first execution environment.

7. The method of claim 1, wherein the master device is operating in a sleep mode when the signaling corresponding to the in-band interrupt is detected, and wherein a second execution environment is unaffected when the first execution environment is interrupted.

8. An apparatus comprising:
a bus interface operable as a bus master interface and adapted to couple the apparatus to a serial bus, wherein each device communicatively coupled to the serial bus is uniquely identified in transactions on the serial bus by a device identifier;
a plurality of execution environments, each configured to perform one or more functions independently of another execution environment; and
a list of device identifiers allocated to a slave device, the list associating each device identifier with one of the plurality of execution environments,
wherein the bus interface is configured to:
detect signaling on the serial bus corresponding to an in-band interrupt asserted by the slave device, wherein the slave device is identified as a source of the in-band interrupt by a first device identifier transmitted by the slave device;
receive a second device identifier transmitted by the slave device as its device address in a response to a command related to the in-band interrupt;
use the second device identifier to select a first execution environment from the list; and
interrupt the first execution environment responsive to the in-band interrupt.

9. The apparatus of claim 8, wherein the second device identifier is allocated to one of a plurality of event sources in the slave device.

10. The apparatus of claim 9, further comprising a controller configured to:
use the bus interface to write the second device identifier to a register in the slave device associated with a source of an event that triggers the in-band interrupt.

11. The apparatus of claim 9, further comprising a controller configured to:
allocate the first device identifier to the slave device during a first dynamic address allocation process; and
allocate the second device identifier to the slave device during a second dynamic address allocation process,
wherein at least one dynamic address allocation process is performed in accordance with an I3C protocol.

12. The apparatus of claim 9, further comprising a controller configured to:
allocate the first device identifier to the slave device during a first dynamic address allocation process; and
use the serial bus to write the second device identifier to a register in the slave device associated with a first event source.

13. The apparatus of claim 8, further comprising a controller configured to:
wake the first execution environment when the first execution environment is in a dormant state when the signaling corresponding to the in-band interrupt is detected.

14. The apparatus of claim 8, wherein the apparatus is operating in a sleep mode when the signaling corresponding to the in-band interrupt is detected, and wherein a second execution environment is unaffected when the first execution environment is interrupted.

15. The apparatus of claim 14, wherein the second execution environment remains in a sleep mode when the first execution environment is interrupted.

16. A method performed at a slave device coupled to a serial bus, comprising:
maintaining a first device identifier used to identify the slave device in transactions conducted over the serial bus, wherein each device communicatively coupled to the serial bus is uniquely identified in transactions on the serial bus by a device identifier;
detecting a first event generated by a first event source;
initiating an in-band interrupt on the serial bus after detecting the first event;
transmitting the first device identifier in a first transaction conducted during processing of the in-band interrupt; and
transmitting a second device identifier assigned to the first event source in a second transaction conducted during processing of the in-band interrupt,
wherein the second device identifier is transmitted to enable a master device to select an execution environment configured to respond to the first event.

17. The method of claim 16, further comprising:
receiving the first device identifier during a first dynamic address allocation procedure.

18. The method of claim 17, wherein the first dynamic address allocation procedure is performed in accordance with an I3C protocol.

19. The method of claim 16, wherein the second device identifier is written to a register of the slave device by the master device.

20. The method of claim 16, wherein the second device identifier is preconfigured during manufacture or initiation of the slave device.

21. The method of claim 17, further comprising:
receiving the second device identifier during a second dynamic address allocation procedure.

22. The method of claim 16, wherein the first event source is one of a plurality of event sources, each event source having an associated device identifier to be transmitted in in-band interrupt procedures.

23. A non-transitory processor-readable storage medium having instructions stored thereon which, when executed by at least one processing circuit, cause the at least one processing circuit to:
detect a first event generated by a first event source at a slave device coupled to a serial bus, wherein each device communicatively coupled to the serial bus is uniquely identified in transactions on the serial bus by a device identifier;
initiate an in-band interrupt on the serial bus after detecting the first event;
transmit a first device identifier in a first transaction conducted during processing of the in-band interrupt; and
transmit a second device identifier assigned to the first event source in a second transaction conducted during processing of the in-band interrupt, the second device identifier being transmitted to select an execution environment configured to respond to the first event.

24. The storage medium of claim 23, wherein the first device identifier is received during a first dynamic address allocation procedure.

25. The storage medium of claim 24, wherein the first dynamic address allocation procedure is performed in accordance with an I3C protocol.

26. The storage medium of claim 23, wherein the second device identifier is written to a register of the slave device by a master device.

27. The storage medium of claim 23, wherein the second device identifier is preconfigured during manufacture or initiation of the slave device.

28. The storage medium of claim 24, wherein the second device identifier is received during a second dynamic address allocation procedure.

29. The storage medium of claim 23, wherein the first event source is one of a plurality of event sources, each event source having an associated device identifier to be transmitted in in-band interrupt procedures.
